(19) United States
(12) Patent Application Publication
(10) Pub. No.: US 2013/0110836 A1
(43) Pub. Date: May 2, 2013

(54) SYSTEM AND METHOD FOR COMMUNITY AND GROUP ORGANIZATION FOR ACTIVITIES AND EVENTS

(71) Applicant: JEFFREY MARK TOMBERG, Old Greenwich, CT (US)

(72) Inventor: JEFFREY MARK TOMBERG, Old Greenwich, CT (US)

(73) Assignee: OOZBOP, LLC

(21) Appl. No.: 13/359,184

(22) Filed: Jan. 26, 2012

Related U.S. Application Data
(60) Provisional application No. 61/552,771, filed on Oct. 28, 2011.

(51) Int. Cl. G06F 17/30

(52) U.S. Cl. 707/737; 707/E17.046

(57) ABSTRACT

A system is disclosed for organizing at least one community. The system includes: a memory having a plurality of modules, including: a community manager module, a community member module, a group manager module, a group member module, and an activity creator module providing functions for an activity creator of the at least one group. The system has a database storing information regarding the community members and the group members. The at least one community corresponds to a pre-existing member-based organization, and each of the plurality of community members of the at least one community is a member of the corresponding organization. Each community is organized in the system to include individuals, but not groups, and one or more of the individuals is also a member of at least one group. A corresponding method is described.

### CROSS-REFERENCE TO RELATED APPLICATIONS

This application claims the benefit of U.S. provisional application No. 61/552,771, filed on Oct. 28, 2011, which is hereby incorporated by reference herein in its entirety.

### FIELD OF THE INVENTION

The present invention relates to a system and method for organization of communities and groups regarding events and activities.

### BACKGROUND

Systems for organizing individuals in an online environment are known. For example, social networking systems allow for individuals to set up their own personal pages, and to allow others to view the personal pages. In these systems, individuals may be linked as being “friends” so that they may view each others personal pages, and may keep in touch with each other by updating information on the pages.

Online and computer systems which allow individuals to join together in activities, such as golf or other sports, are also known. Organizations, such as country clubs, may use such systems to keep track of the use of their activity facilities, and which individuals are using such facilities.

### SUMMARY OF THE INVENTION

According to one embodiment, there is provided a computerized system for organizing at least one community, each having a plurality of community members, and at least one group, each having a plurality of group members. The system comprising: a memory having a plurality of modules, comprising: a community manager module providing functions for a community manager of the at least one community; a community member module providing functions for a community member of the at least one community; a group manager module providing functions for a group manager of the at least one group; a group member module providing functions for a group member of the at least one group; and an activity creator module providing functions for an activity creator of the at least one group; and a database storing information regarding the community members and the group members, wherein the at least one community corresponds to a pre-existing member-based organization, and each of said plurality of community members of said at least one community is a member of said corresponding organization, wherein each community is organized in the system to include individuals, but not groups, and one or more of said individuals is also a member of at least one group.

According to an aspect of the embodiment, the activity creator module allows the activity creator to set a time at which the activity will occur, and provides notification to the group members of the occurrence of an activity start time.

According to an aspect of the embodiment, the activity creator module allows the activity creator to set a time at which the activity will occur, where the time of occurrence may be set to occur only within certain months on a seasonal basis.

According to an aspect of the embodiment, the community manager module allows a community manager to set the attributes of a target group of community members to whom a message is sent.

According to an aspect of the embodiment, the attributes correspond to an activity associated with the members of the target group, and/or to specific attributes shared by those members, such as gender or membership in a specific group.

According to an aspect of the embodiment, the community manager module provides a report to the community manager regarding the use by the community members of the system for organizing.

According to an aspect of the embodiment, the report comprises information of at least one of how many community members have used the system for organizing within a given time range, how many groups exist, an identification of activity creators, how many activities a community member has participated in within a given time period, which community members have used the system for organizing the most or least, an aggregate of the types of activities participated in by the community members, or whether or not an activity took place within the community.

According to an aspect of the embodiment, the group manager module allows the group manager to sign up a group member for an activity, decline a group member for an activity or cancel a group member from an activity on their behalf by proxy.

According to an aspect of the embodiment, the group manager module allows the group manager to set some group members as hidden members, where a group member listing of the group members provided to the group members lists all of the group members other than the hidden members.

According to an aspect of the embodiment, the activity creator module allows the activity creator to set the group members who are sent an activity sign up list of the group members signed up for an activity after the cutoff time.

According to another embodiment, there is provided a non-transitory computer readable medium storing a program for operating a system for organizing at least one community, each having a plurality of community members, and at least one group, each having a plurality of group members, the program when executed by a computer, performing a plurality of steps provided by modules. The modules comprising: a community manager module providing functions for a community manager of the at least one community; a community member module providing functions for a community member of the at least one community; a group manager module providing functions for a group manager of the at least one group; a group member module providing functions for a group member of the at least one group; and an activity creator module providing functions for an activity creator of the at least one group; and wherein the at least one community corresponds to a pre-existing member-based organization, and each of said plurality of community members of said at least one community is a member of said corresponding organization, wherein each community is organized in the system to include individuals, but not groups, and one or more of said individuals is also a member of at least one group.

According to an aspect of the embodiment, the activity creator module allows the activity creator to set a time at which the activity will occur, and provides notification to the group members of the occurrence of an activity start time.

According to an aspect of the embodiment, the activity creator module allows the activity creator to set a time at which the activity will occur, where the time of occurrence may be set to occur only within certain months on a seasonal basis.

According to an aspect of the embodiment, the community manager module allows a community manager to set the attributes of a target group of community members to whom a message is sent.

According to an aspect of the embodiment, the attributes correspond to an activity associated with the members of the target group, and/or to specific attributes shared by those members, such as gender or membership in a specific group.

According to an aspect of the embodiment, the community manager module provides a report to the community manager regarding the use by the community members of the system for organizing.

According to an aspect of the embodiment, the report comprises information of at least one of how many community members have used the system for organizing within a given time range, how many groups exist, an identification of activity creators, how many activities a community member has participated in within a given time period, which community members have used the system for organizing the most or least, an aggregate of the types of activities participated in by the community members, or whether or not an activity took place within the community.

According to an aspect of the embodiment, the group manager module allows the group manager to sign up a group member for an activity, decline a group member for an activity or cancel a group member from an activity.

According to an aspect of the embodiment, the group manager module allows the group manager to set some group members as hidden members, where a group member listing of the group members provided to the group members lists all of the group members other than the hidden members.

According to an aspect of the embodiment, the activity creator module allows the activity creator to set the group members who are sent an activity sign up list of the group members signed up for an activity after the cutoff time.

According to another embodiment, there is provided a method for operating a system for organizing at least one community, each having a plurality of community members, and at least one group, each having a plurality of group members.

The method comprises: performing functions, via a computer, of at least one of: a community manager of the at least one community; a community member of the at least one community; a group manager of the at least one group; a group member of the at least one group; or an activity creator of the at least one group; and wherein the at least one community corresponds to a pre-existing member-based organization, and each of said plurality of community members of said at least one community is a member of said corresponding organization, wherein each community is organized in the system to include individuals, but not groups, and one or more of said individuals is also a member of at least one group.

According to an aspect of the embodiment, the activity creator sets a time at which the activity will occur, and providing notification to the group members of the occurrence of an activity start time.

According to an aspect of the embodiment, the activity creator sets a time at which the activity will occur, where the time of occurrence is set to occur only within certain months on a seasonal basis.

According to an aspect of the embodiment, the community manager sets the attributes of a target group of community members to whom a message is sent.

According to an aspect of the embodiment, the attributes correspond to an activity associated with the members of the target group, and/or to specific attributes shared by those members, such as gender or membership in a specific group.

According to an aspect of the embodiment, there is provided a report to the community manager regarding the use by the community members of the system for organizing.

According to an aspect of the embodiment, the report comprises information of at least one of how many community members have used the system for organizing within a given time range, how many groups exist, an identification of activity creators, how many activities a community member has participated in within a given time period, which community members have used the system for organizing the most or least, an aggregate of the types of activities participated in by the community members, or whether or not an activity took place within the community.

According to an aspect of the embodiment, the group manager signs up a group member for an activity, declines a group member for an activity or cancels a group member from an activity on their behalf by proxy.

According to an aspect of the embodiment, the group manager sets some group members as hidden members, where a group member listing of the group members provided to the group members lists all of the group members other than the hidden members.

According to an aspect of the embodiment, the activity creator sets the group members who are sent an activity sign up list of the group members signed up for an activity after the cutoff time.

### BRIEF DESCRIPTION OF FIGURES

FIG. 1 illustrates an example of the organization of communities and groups according to an embodiment of the invention.

FIG. 2 illustrates a computing system for implementing the invention according to an embodiment of the invention.

FIG. 3 illustrates an embodiment of the computing system of FIG. 2 according to an embodiment of the invention.

FIGS. 4A and 4B illustrate a web page including steps for creating an activity.

### DETAILED DESCRIPTION

Organizing activities and events according to communities and groups.

According to aspects of the invention, individuals are organized into communities and groups. The members of both communities and groups are individuals. A community may include one or more of the same individuals as a group. While both members of a community and a group are individuals, a community does not include groups as members. It is possible, however, that all of the members of a particular group are also members of a single community.

A group may be any number of individuals who join together within the system with the purpose of planning and executing any number of activities for that group. The groups may be created as interest or activity based groups, such as a golf group or a group of booklovers, for example. Even further, the system allows for groups based on social interaction rather than merely activity or interest. Thus the group may be made up of individuals who do different things together rather than a group that always performs the same activity. Within the group, group members may set up activities such as golf, cards, dining, outing or any other type of activities. While the overall group membership may remain mostly the same, individuals can be added or removed as needed, each activity would have a unique roster of who is participating. This system automates the reminders and sign up process of determining who will participate for each of the varying activities. The group functionality comprises a number of functions, as described further below. Group managers may have access to view sign-ups and otherwise manage the group.

A community is a member-based organization and is defined by the membership of the organization. Within the system, a community is an entity that is recognized as an organization that has an official membership roster and a well-defined, distinct membership. Communities may include, for example, golf and country clubs, sports clubs, health and fitness clubs, religious institutions, civic or community institutions, educational institutions, etc. Communities may have much or all of the same functionality as groups, and additionally a community may have further functionality, such as a community message center, where community managers may send targeted messages and alerts to segments of their membership, reports and the ability to upload the membership roster of the community.

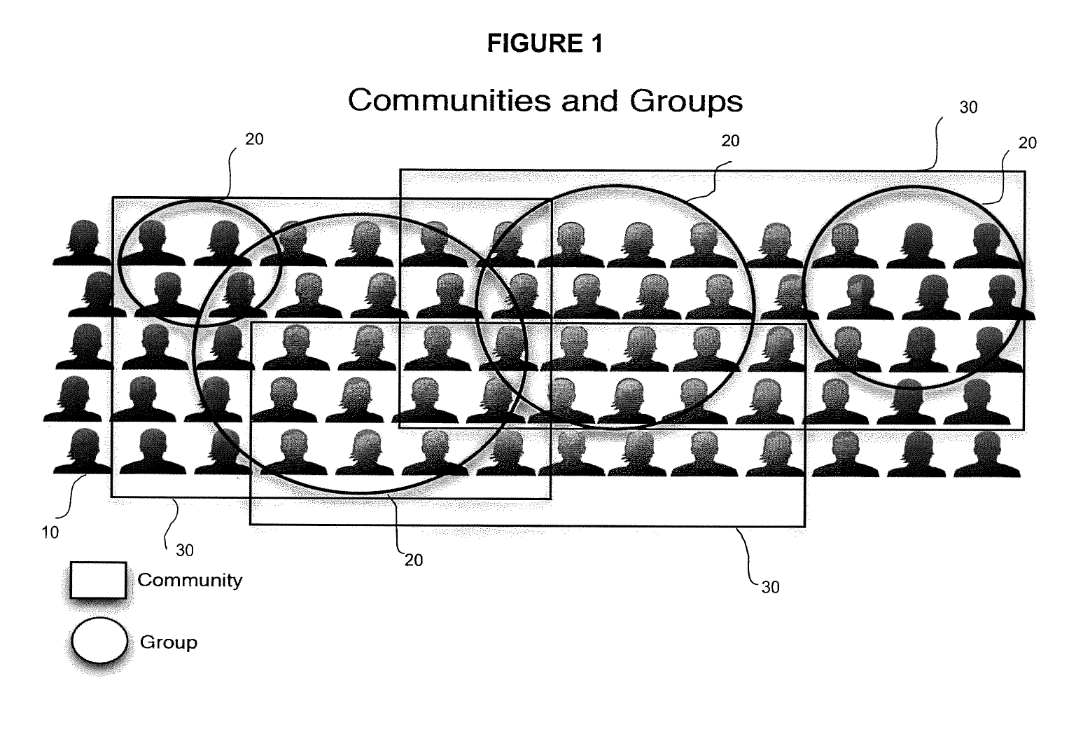

FIG. 1 illustrates an example of the organization of communities and groups. The grouping of individuals 10 within a group 20 as members are shown in FIG. 1 by circles, while the organization of individuals 10 within a community 30 as members are shown in FIG. 1 by squares. As can be seen, the members of a particular group 20 may be entirely contained within a single community 30, or may be shared by more than one community 30, or may not be a member of any community 30. It is also possible, although not shown in FIG. 1, that the members of a community 30 may be entirely contained within one group 20. Individuals 10 may be members of one or more communities 30 or one or more groups 20. Further, the members of one group 20 may be entirely contained within another group 20. That is, all of the individuals 10 of one group 20 may also be part of the individuals 10 of another group.

A group is a group of individuals who may have common interests, be associated socially, or geographically such as being on the same street, for example, where the individuals have been assigned in the system as being members of the group. Groups are not communities, however. A group is not limited to just one activity, but members of such a group may participate in a plurality of different activities. Further, a member of a group need not participate in any activities. A group enables group members to organize, manage and interact with people they wish to do things with and socialize with. Examples of activities include tennis, golf, or games, such as bridge or checkers.

Communities may be groups such as a country club or a social or religious organization, for example, where the community members have been assigned in the system as being members of the community. Thus the individuals of a community may all belong to the same institution, such as a country club or church, for example, and are listed as members of that institution. Communities provide events instead of activities for its members to participate in. In practice, however, events and activities may be similar. For example, a weekly golf game for a group is an activity, whereas a golf tournament at a country club (the community) is an event. Depending on the type of event, a user, upon signing up for an event may be asked questions such as “How many will be attending?” or “Do you need a high chair?” Events may be, for example, a sports tournament, such as a golf or tennis tournament, a picnic or a dance.

Communities and groups have managers, which have the authority to perform certain management functions, as described below. Community managers manage communities, while group managers manage groups. A group manager has the authority to perform certain management functions as described below, and may grant authority to an individual to be a group manager to perform management functions. In a similar fashion, a community manager may grant authority to an individual to perform management functions for communities. Further, the system includes an activity creator, where any member of a group may be an activity creator who creates an activity.

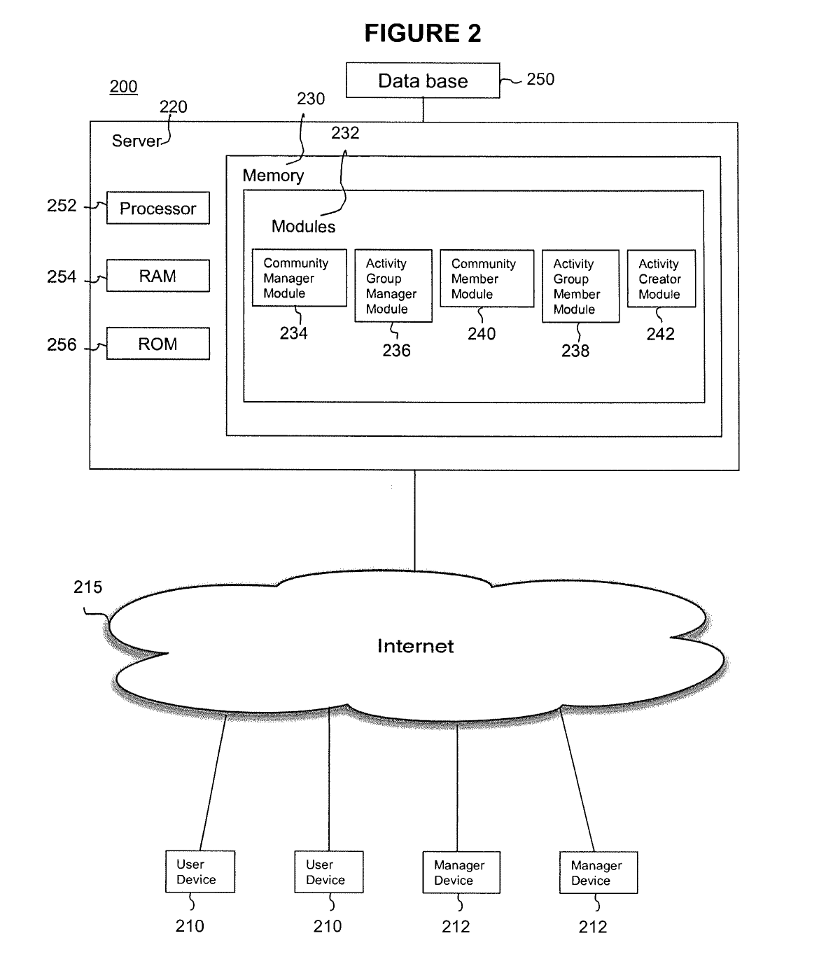

FIG. 2 illustrates a computing system 200 that may be used according to one or more embodiments of the invention. The system 200 may include a server 220 with a processor 252 for controlling overall operation of the system. The server 200 may also include a variety of non-transitory computer readable media including, for example, a ROM (read only memory) 256, a RAM (random access memory) 254, and a memory 230. Software may be stored in the memory 230 and/or other computer readable media to provide instructions to the processor 252 to enable the server to perform various functions. The server 220 may be connected to a database 250, which stores information, such as information regarding the communities, groups, and individual users of the system such as community members and group members. While FIG. 2 illustrates a single server 220 and a single database 250 for ease of illustration, in general, the server 220 may comprises one or more servers, and the database 250 may comprise one or more databases interconnected to the servers.

The server 220 may be connected to user devices 210 and manager devices 212 via the internet 215. Alternatively, the server 220 may be connected to user devices 210 and manager devices 212 more directly via a LAN (local area network) (not shown). The user and manager devices 210 and 212 may be the same type of computing device or different types of computing devices. The user device and manager device 210 and 212 may be the same device. The user and manager devices 210 and 212 may be any number of computing devices such as a personal computer, laptop, tablet, or smartphone, for example, which may include a processor, display, and data input unit.

The memory 230 may include a number of modules 232 for implementing the organization system. The modules 230 may be implemented as software stored in the memory 230 and/or firmware or hardware. While FIG. 2 illustrates the modules 232 as being included in the memory 230, one or more of the modules may be implemented in any one or more of the RAM 254, ROM 256, user devices 210 or management devices 212.

The modules 230 may include, for example, a community manager module 234, a group manager module 236, a group member module 238, a community member module 240, and an activity creator module 242. The community manager module 234 provides functions a community manager may perform. The community member module 240 provides functions a community member may perform. The group manager module 236 provides functions a group manager may perforin. The group member module 238 provides functions a group member may perform. The activity creator module 242 provides functions for an activity creator, such as a member of a group.

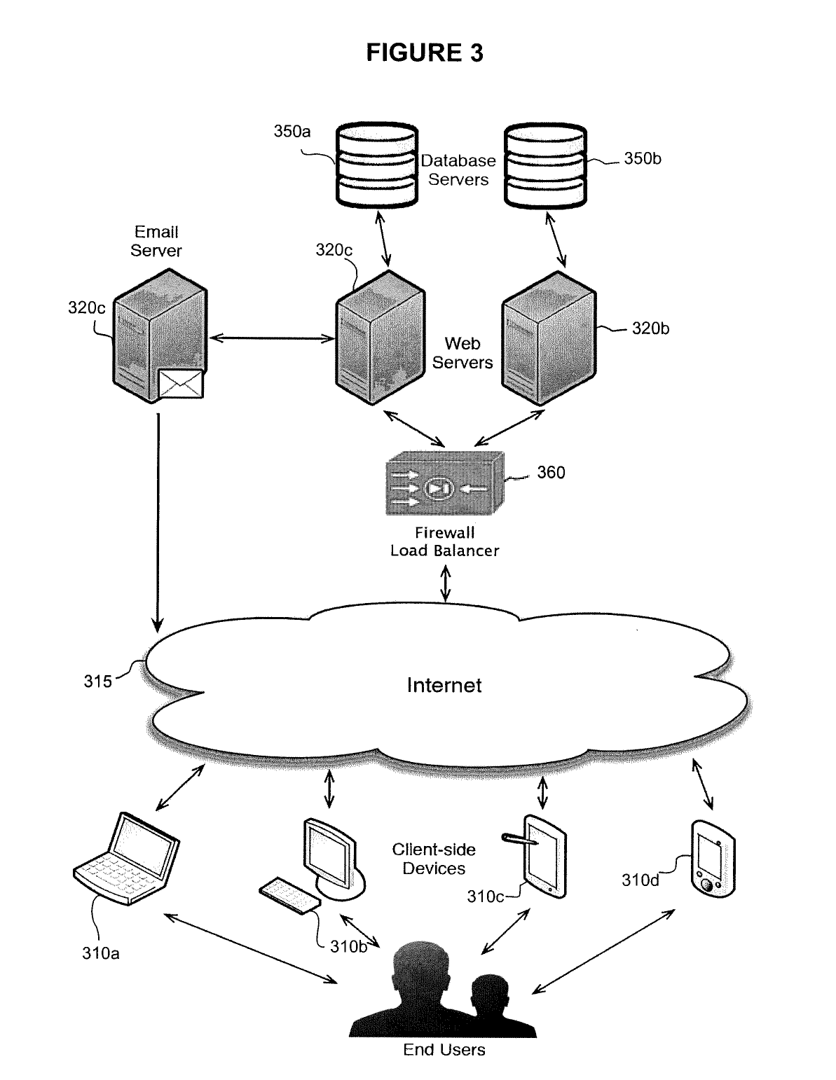

FIG. 3 illustrates one embodiment of the system of FIG. 2. The system 300 in FIG. 3 includes web servers 320a and 320b, and email server 320c which correspond to the server 320 shown in FIG. 2. The system 300 in FIG. 3 also includes database servers 350a and 350b corresponding to the database 250 of FIG. 2. The web servers 320a and 320b, and email server 320c are connected to the client devices 310a, 310b, 310c and 310d via the internet 315, where each of the client devices 310a, 310b, 310c and 310d may correspond to either a user device 210 or manager device 212 as shown in FIG. 2. In the implementation of FIG. 3, the web servers 320a and 320b are connected to the internet 315 via a firewall load balancer 360.

User Functions

Each individual user, such as a member or potential member of a group, or a member of a community, of the organization system will in general have a user profile including personal information regarding the user, where such information may be stored in the database 250 in the system 200 of FIG. 2, for example. The user may update their profile through one of the user devices 210. The user profile may include information such as the name of the user, a profile icon, user gender, user email address, user home and mobile phone numbers, user address information such as city, state and zip code, and notification preferences and wall notification preferences. The notification preferences provide the method which the user desires to be notified regarding group activities or community events and may be, for example, email notification and/or text notification. The wall notification preferences specify how a user wishes to be notified on a group or community wall of information regarding a group activity or community event. Examples of wall notification preferences include: anytime someone posts on the wall, only when someone replies to a post the user made, never notify about wall posts, notify when someone likes the user's post, and never notify about likes.

The system includes a dashboard feature for users. When a user logs in to the system, the first page the user sees may include the dashboard which provides the user easy access to functions such as the following: creating a group, a display of all the group activities and/or community events the user has signed up for, a display of all the group activities and/or community events the user is eligible to sign up for, a listing of all the groups the user is a member of, and all the communities the user is a member of.

Additionally, the system may provide a user with access to a personal calendar regarding activities and events, once the user has logged in. The personal calendar shows the group activities and/or community events a user has signed up for.

The system also provides a user with a search function. The search function allows a user to search for groups, which are open to the public to join. The user may, for example, set a radius in the search where the groups are searched within the set radius of the zip code of the user. The search results may display the group name and a group description. The search results may also provide a link which allows the user to request to join a listed group.

Groups

The groups may be of different group types, for which a particular user may or may not be eligible to join. The group types may include, for example, Public, Private, Community Public and Community Private. For a Public type group, any user can search and request to join the group. For a Private type group, a group manager of the group must invite a user to be a member of the group. For a Community Public group, any user who is a member of the community may search and request to join the group. For a Community Private group, group managers must invite each member of the group, but only members of the community may be invited.

The system may also include a group directory which provides a listing of all group members, where the group members of a group may have access to the group directory. The information in the group directory, in addition to the listing of the group members, may also include user profile information such as the name of the user, a profile icon, user gender, user email address, user home and mobile phone numbers, and user address information such as city, state and zip code. Additionally, the group directory may include the status of each member of the group, where the status may be group captain, manager, or group member. A group captain is the creator of the group. Group managers may change the status of a group member. For example, a group manager may change the status of a group member to a group manager.

The system allows a group member to view activities of the member's group, and to sign up for an activity, decline an activity or cancel an activity the member had signed-up for. The group member may, for example, view X number of upcoming group activities for the group and sign up, decline or cancel each of the viewed activities. For example, for a group where the activity is golf, the group member may view X listed golf games, and may choose to sign up for each golf game, decline specific golf games or cancel if already signed-up. The number X of listed activities may be set by the group creator, such as a manager, when the group is created, or may be modified after the group is created.

Once a member signs up for an activity, the member may add the activity to a calendar such as the personal calendar for the member provided by the system, and/or to other calendars such as Outlook, iCal or Google calendars. For example, if the activity signed up for is tennis, the group member may add the tennis game to a calendar.

For the personal calendar feature, the personal calendar of a user may display all previous and upcoming activities with color coding. The activities displayed are those of the groups for which the user is a member. The colors for the coding may indicate whether or not the member signed up for the activity. Users can move forward or backward through the months and sign up, decline or cancel activities directly from the calendar.

The system also may include a group wall feature. The group wall feature allows group members to post messages to members of the group and to reply to messages posted from group members. A group member may also like/unlike any of the messages posted.

The system may also include a photo gallery feature. This is an area where group members can post photos to share with the rest of the group. The photos can be organized into subfolders, with optional permissions placed on each subfolder to control access. The photos can have captions added by the group member who uploads them. For each photo, other group members have the ability to comment on the photo or like/unlike it.

The system may include a group poll feature. The group poll feature allows any group member to send a poll out to all the other group members of the group. The poll can be used for scheduling activities, getting feedback on past activities, or asking fun questions of the group. The poll types may include, for example: Boolean with yes/no or true/false questions, Ranking, where the poll creator adds their own answers to be ranked and lets each respondent put a sort order on the answers, Single Choice, where respondents to the poll may only choose a single answer, or Multiple Choice, where respondents may choose more than one answer.

The system may include a post results feature which allows a group member to post a resultant score for a scored activity which may be viewed by other activity members of the scored activity.

The system may include a member rating feature which allows a group member to anonymously rate other members of the group participating in an activity. For example, group members could anonymously rate the other members of the group from 1-5 stars. This functionality could be important if some group members fail to follow the normal protocols and the other group members wish to inform the offending group member that their behavior is not acceptable.

The system may include a shared email address feature which allows users to share an email address in using the system. When a shared email is detected at login, the user will be prompted to select who they are logging in as. Upon selection, the session will then proceed as that person. This feature is helpful for couples who often use the same email address, and when the system uses an email address as a unique identifier, this feature allow for shared email addresses.

The system may include a send message feature. The send message feature allows any group member to send a message to any number of the other group members of a group. The send message feature also contains a “send to all” feature to simply send the message to all group members at once. The message will be delivered either by email and/or text based on the message recipient's settings in their profile. The default delivery method may be email.

The system may include a leave group feature. The leave group feature allows a group member to remove themselves from a group. If the group member selects to leave the group, the group member may be prompted to confirm that they wish to leave the group.

The system may include a file library feature. The file library feature allows a group member to create subfolders and upload files to be shared with the group. By default, each subfolder can be viewed by the entire group, however the subfolders can be given permissions so that only certain group members will see, and have access to, everything within that subfolder. The following file types are allowed into the File Library, for example: avi, csv, doc, docx, gif, jpg, mov, mp3, mpg, pdf, png, ppt, pptx, psd, rar, rtf, txt, way, wmv, xls, xlsx, zip.

The system may include a link master feature associated with the file library feature. A link master is a special file that a group member can use to create a linked index to other files within the group's file library. For instance, if the file library is used to store documents for a meeting, a link master can be created as the agenda for the meeting and then each document referred to in the agenda can be linked to from the link master. It provides other group members with a fast and easy way to access files that might be spread across multiple folders and sub-folders.

Group Manager Features

The system may include a view activity sign up feature which may be used only by group managers. The view activity sign up feature allows a group manager to view who has signed up or declined for upcoming activities in the group, even if the sign up period is still open for that activity. The view activity sign up feature provides a way of monitoring progress of each activity's sign-ups.

The system may include an add new group member feature which may be used only by group managers. The add new group member feature allows a group manager to invite new individuals to the group. An individual is not considered to be a group member until the individual has been invited to join the group and accepts the invitation. In general, the invitation may be sent from any of the group managers. Thus, one group manager may send the invitation on behalf of another group manager of the same group.

The system may include a remove member from group feature which may be used only by group managers. The remove member from group feature allows group managers to remove members from the group.

The system may include a manage hidden members feature which may be used only by group managers. The manage hidden members feature allows a group manager to set some of the group members as hidden members. Hidden members are group members who are members of the group, but whose name will not be displayed in any group list. Those group members who are not hidden members will have their name displayed in any group list. Hidden members will receive all full group notifications. The manage hidden members feature allows a group manager to assign someone who is not interested in engaging in activities of the group to act as a “helper” who can assist with the group management.

The system may include a group settings feature which may be used only by group managers. The group settings feature allows a manger to change high-level information about the group, such as name or description, or to disable the group, for example.

The system may include a sign up/cancel by proxy feature which may be used only by group managers. The sign up/cancel by proxy feature allows a group manager to sign up, decline or cancel an activity for any member of the group on their behalf by proxy. The group manage may perform the sign up, decline or cancel, for example, from the view activity sign up page.

The system may have an app chooser feature. The app chooser feature allows a creator of a group, when creating a new group, to decide which applications should be made available to the group. The chosen apps can be changed after the group is created, by a group manager, from the Group Settings area. The applications may include, for example, Polls, Group Wall, File Library, Photo Gallery, Calendar, Directory, and Send Message to Members.

Activity Creation and Activity Creator Functions

In general, a group member may create an activity for the group. In this regard, the system may include a create activity feature which may be used by any group member. The create activity feature allows a group member to set up an activity for the group. The options for the activity are described below, where the activity creator sets the options.

The activity created may have a type, such as golf, tennis, book club, or poker game, for example. Additionally the activity may include an activity description, activity start time, activity duration, and activity location. In general, the activity creator sets the activity type, activity description, activity start time, activity duration, and activity location.

The activity may be open or closed. An open activity is viewable by all of the group members. For a closed activity, the activity creator will choose those members from the group who should be allowed to see, and sign up for, the activity. If the activity is closed, it will not be displayed on any group members' page or dashboard unless they are in an “allowed list”, where the allowed list may be set by the activity creator.

The system may have a cut off for sign ups feature, which may be used by the activity creator. The cut off for sign ups feature allows the activity creator to set a cutoff time prior to a start time of each instance of the activity for the purpose of sending reminders to the group members. The cutoff time may have a default such as three days prior to the start time, but the creator may set the cutoff time to any value. Based on cutoff time, the schedule for the reminder messages sent to the group members is determined. For example, for a cutoff time of three days, the first reminder may be sent to the group members six days prior and the second reminder may be sent four days prior to the start time. As another example, if the cutoff time is seven days, then the first reminder may be sent eleven days prior to the activity start time and the second reminder may be sent nine days prior to the start time. Once the cutoff time has passed, group members may no longer sign up or decline for the activity. However, group managers can still sign up or decline group members by proxy. Additionally, group members who had already signed up for the activity can cancel from that activity after the cutoff time.

The activity creator may set the list of who will be sent a sign up list for the activity. The list of who will be sent a sign up list may include both group members as well as individuals not in the group. The individuals selected for the list are sent the sign up list after the cutoff date.

The activity creator may set the maximum number of members who can participate in each instance of the activity created by the activity creator. Once the number of members signed up for an instance of an activity has reached the maximum number, no further members are allowed to sign up.

The activity creator may set the notifications to be sent regarding the activity created. The activity creator may set notifications for either the creator alone, for group managers, or the entire group according to certain events. The notifications are sent either by email and/or text based on the recipient's profile. The events include: any member signing up for the activity, any member declining the activity, any member cancelling their sign up for the activity, there being only one spot left for an activity, and there being no spots left for an activity.

The system may have a notify now feature, which may be used by the activity creator. If the creator chooses yes for the notify now feature, then either all of the members of the group (for open activities) or members of the group on the “allowed list” (for closed activities) will receive an immediate notification announcing the activity as soon as it is created. This immediate notification is in addition to the normal reminder notifications.

The system may have a seasonal activity feature, which may be used by the activity creator. The seasonal activity feature allows the activity creator to set a time interval for which the activity will repeat, and provides notification to the group members of the recurrence of an activity start time. For example, the activity may be set to repeat only within certain months. A weekly golf game, for example may be set to repeat only from May until October.

The system may have a display sign-ups feature, which may be used by the activity creator. The display sign-ups feature allows the activity creator to decide whether or not to display the list of who has already signed up for an activity to the other group members. If set to “yes” then the list of those signed-up will be displayed for each activity.

The system may have an adding guests to activity signups feature, which may be used by the activity creator. The adding guests to activity signups feature allows the activity creator to decide whether to allow group members to bring guests along for the activity. If set to “yes” then when a member signs-up for the activity, they are asked whether they are bringing any guests and how many they are bringing. The guests are included in the sign-up lists and any activity count, but are not considered members of the group.

The system may have a schedule feature, which may be used by the activity creator to set a time of recurrence of the activity. The time of recurrence may be set, for example as follows: only once, daily, weekly, monthly, annually, or custom. For only once, the activity creator chooses a single day the activity will occur on. For daily, the activity creator chooses the starting date for the activity and then the activity recurs daily. For weekly, the activity creator chooses which day(s) of the week the activity will occur on, how many weeks between recurrence, and the start date. For instance, the activity creator could set the schedule to occur every two weeks on Tuesdays and Thursdays, or every week on Saturday. For monthly, the schedule could be set according to two options, for example. As a first option, the activity creator could set the activity to occur on the ith day of every nth months, for example, where both the options for the ith day and nth months are changeable. As a second option, the activity creator could set the activity to occur on the ith Monday of every nth month, where the ith Monday and nth month may be changed. For annually, the activity creator selects the month and day on which the activity should occur. For custom, the activity creator inputs a number of custom dates for the activity. This is for any activity where there is no set pattern for the recurrence.

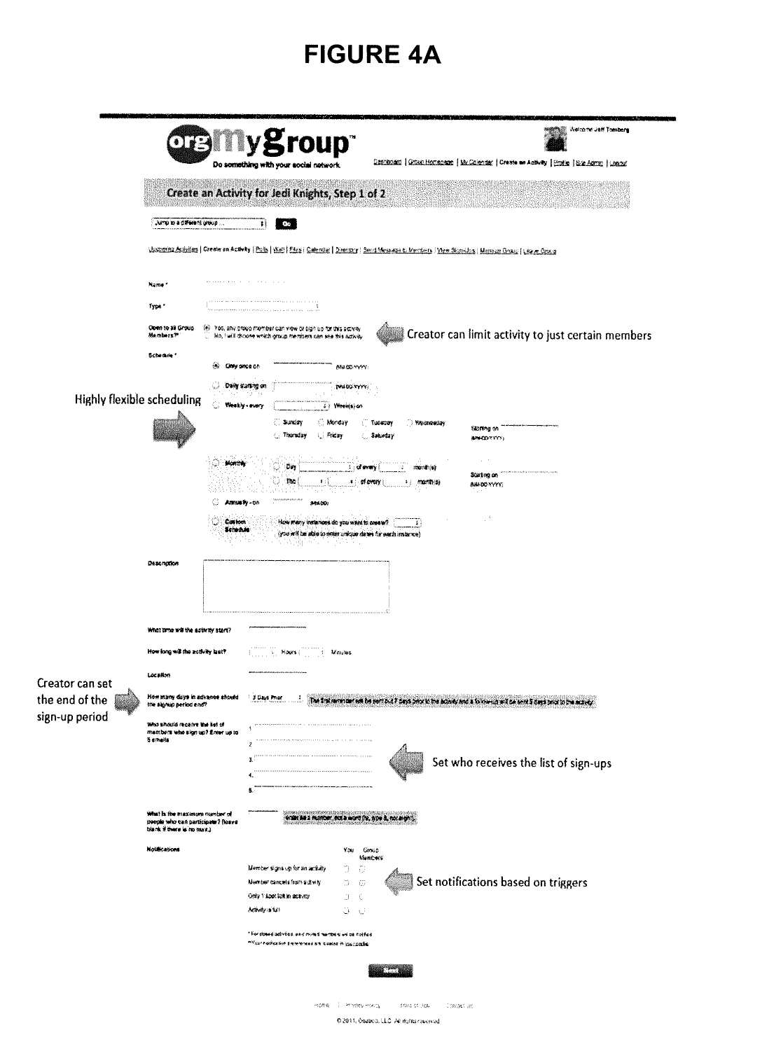

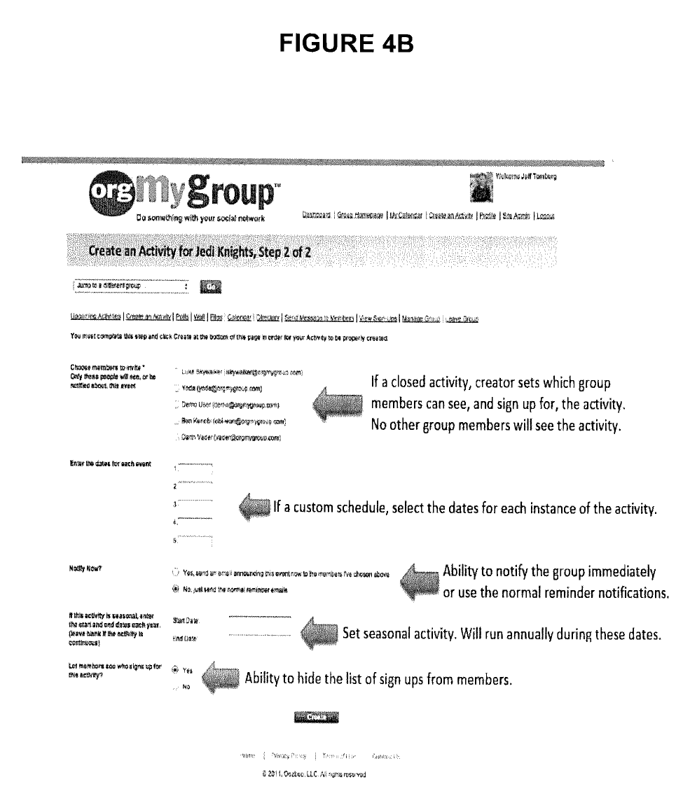

FIGS. 4A and 4B illustrate a web page including steps for creating an activity, which may be used by an activity creator according to an embodiment of the invention.

The system may have an automatic select function which automatically selects members for an activity based on group members who have signed up for an activity, and assigns the group members to an activity based on the type of activity. If selected, this feature will automatically select members for the activity based on the number of members who have signed up and what type of activity it is. For instance, a golf activity will automatically place people into 4-somes, a singles tennis activity will put people into 2-somes, etc. There may also be rules regarding exceptions when people prefer to play with certain members or prefer not to play with others.

Communities

The system provides for a list view of all upcoming community events to be provided to community members. The community member can sign up, decline or cancel for each event from this list. When signing up for an event, the community member may enter how many people will be attending, and provide special instructions for the event, such as the need for a high chair at a dinner event.

The system may include a community wall feature. The community wall feature allows community members to post messages to members of the community and to reply to messages posted from community members. A community member may also like/unlike any of the messages posted.

The system may also include a community photo gallery feature. This is an area where community members can post photos to share with the rest of the community. The photos can be organized into subfolders, with optional permissions placed on each subfolder to control access. The photos can have captions added by the member who uploads them. For each photo, other community members have the ability to comment on the photo or like/unlike it.

The system may include a community calendar feature. For the community calendar feature, the community calendar of a community member may display all previous and upcoming events with color coding. The colors for the coding may indicate whether or not the community member signed up for the event. Community members can move forward or backward through the months and sign up or cancel events directly from the calendar.

The system may include a community directory which provides a listing of all community members, where the community members of a community have access to the community directory. The information in the community directory, in addition to the listing of the community members, may also include user profile information such as the name of the user, a profile icon, user gender, user email address, user home and mobile phone numbers, and user address information such as city, state and zip code. Additionally, the group directory includes the status of each community member of the community, where the status may be manager, or community member. Community managers may change the status of community members. For example, a community manager may change the status of a community member into a community manager.

The system may include a file library feature. The file library feature allows a community member to create subfolders and upload files to be shared with the community. By default, each subfolder can be viewed by the entire community, however the subfolders can be given permissions so that only certain community members will see, and have access to, everything within that subfolder. The following file types are allowed into the file library, for example: avi, csv, doc, docx, gif, jpg, mov, mp3, mpg, pdf, png, ppt, pptx, psd, rar, rtf, txt, way, wmv, xls, xlsx, zip.

The system may include a link master feature associated with the file library feature. A link master is a special file that a community member can use to create a linked index to other files within the community's file library. For instance, if the file library is used to store documents for a meeting, a link master can be created as the agenda for the meeting and then each document referred to in the agenda can be linked to from the link master. It provides other community members with a fast and easy way to access files that might be spread across multiple folders and sub-folders.

Event Creation

The event creation has a corresponding functionality to the activity creation as described in the above section on activity creation and activity creator functions, except that only community managers can create events, unlike groups where any member can create an activity.

Community Manager Features

The system may include a view event sign up feature which may be used only by community managers. The view event sign up feature allows a community manager to view who has signed up for an upcoming event in the community, even if the sign up period is still open for that event. The view event sign up feature provides a way of monitoring progress of each event's sign-ups.

The system may include a send message to all feature which may be used only by community managers. The send message to all feature allows the community manager to send a message to all members of the community. The message will be sent as email and/or text based on each community member's settings in their profile.

The system may include a send message to individuals feature which may be used only by community managers. The send message to individuals feature may provide the community managers with a checkbox list of all community members, where the community manager may check off which community members should receive the message.

The system may include a segmented messaging feature which may be used only by community managers. The segmented messaging feature allows a community manager to set the attributes of a target group of community members to whom a message is to be sent. The message is then sent to only those community members in the target group, i.e. to those community members who have the set attribute. The attributes may correspond to an activity associated with the members of the target group and/or specific attributes shared by those members, such as gender or membership in a specific group, for example. The message sent may provide an indication corresponding to the activity associated with the members of the target group, or the topic of potential interest, for example. The segmented messaging feature allows a community manager to communicate easily with a targeted group of people for quick alerts and notifications.

As an example, the segmented message may be sent according to one of three options:

To [male, female, all] members who signed up for a [event or activity type, like golf, tennis, etc] activity that happens on [a particular date];

To [male, female, all] members who are members of [specified group]; or

To all [male, female] members.

The system may include an upload roster feature which may be used only by community managers. The upload roster feature allows a community manager to upload a csv file roster to easily import all members into a database of the system.

The system may include an inactive members feature which may be used only by community managers. The inactive members feature allows a community manager to view a directory listing of inactive members. The inactive members feature also allows a community manager to re-activate members.

The system may include a reports feature which may be used only by community managers. The reports feature provides a report to a community manager regarding the system for organizing the community members, where the report may be anonymously provided to the community manager. The report may contain information, all or some of which may be provided anonymously to the community manager, such as: how many community members have used the system for organizing within a given time range; how many groups exist, an identification of activity creators, how many activities a community member has participated in within a given time period, which community members have used the system for organizing the most or least, an aggregate of the types of activities participated in by the community members, or whether or not an activity took place within the community.

Since communities are a collection of individuals and those individuals may be members of multiple groups that are made up of either all community members or a mix of community and non-community members, the system is able to provide reports on the activities of those community members whether the activity occurs within the community or not. For example, if a community is a golf club and a community member participates in a weekly golf game at the club, then the community report may show that activity. If that same community member is also a member of other groups in the system that are not community public or community private groups for that community, where community membership is not a requirement to be in the group, or if that same community member is also a member of a second community within the system such as at a local synagogue or a group made up of people who live on the same street, then by virtue of the community member's membership in the golf club, the golf club may see reporting about that members' activities in all those groups. In other words, a community manager can view reporting about all the activities that their members participate in, whether that activity is done within that community or not, and that information may be provide anonymously to the community manager.

The reports provide a way for communities to increase their membership and revenue. Many communities poll their members to see what types of activities the members wish to participate in. The polled members, however, often tend to respond with aspirational activities rather than activities they would truly sign up for. As a result, the activities that occur as a result of a poll typically generate less engagement than expected. This system allows for reports on the activities the community members actually do rather than those the community members merely wish to do. Thus if a community sees that a portion of their membership is already doing a particular activity outside of their community the community may decide to start offering that activity as a way to increase member engagement and revenue.

The reports feature may show the community manager a list of activities the community members have participated in within a given date range, where a report viewer chooses the date range, for example. The activities may be sorted according to the number of instances of member participants with the activity that has the largest number of instances of member participants at top. The list may show the name of the activity, whether or not the activity took place within the community, how many instances of the activity were done and how many of their members participated, for example.

1. A computerized system for organizing at least one community, each having a plurality of community members, and at least one group, each having a plurality of group members, the system comprising:
a memory storing a plurality of modules, comprising:
a community manager module providing functions for a community manager of the at least one community;
a community member module providing functions for a community member of the at least one community;
a group manager module providing functions for a group manager of the at least one group;
a group member module providing functions for a group member of the at least one group; and
an activity creator module providing functions for an activity creator of the at least one group; and
a database storing information regarding the community members and the group members,
wherein the at least one community corresponds to a pre-existing member-based organization, and each of said plurality of community members of said at least one community is a member of said corresponding organization,
wherein each community is organized in the system to include individuals, but not groups, and one or more of said individuals is also a member of at least one group,
wherein the at least one community comprises a plurality of communities, and wherein at least one group member is a member of more than one community of the plurality of communities.

2. The system of claim 1, wherein the activity creator module allows the activity creator to set a time at which the activity will occur, and provides notification to the group members of the occurrence of an activity start time.

3. The system of claim 2, wherein the activity creator module allows the activity creator to set a time at which the activity will occur, where the time of occurrence may be set to occur only within certain months on a seasonal basis.

4. The system of claim 1, wherein
the community manager module allows a community manager to set the attributes of a target group of community members to whom a message is sent.

5. The system of claim 4, wherein the attributes correspond to an activity associated with the members of the target group, and/or to specific attributes shared by those members.

6. The system of claim 1, wherein
the community manager module provides a report to the community manager regarding the use by the community members of the system for organizing.

7. The system of claim 6, wherein
the report comprises information of at least one of how many community members have used the system for organizing within a given time range, how many groups exist, an identification of activity creators, how many activities a community member has participated in within a given time period, which community members have used the system for organizing the most or least, an aggregate of the types of activities participated in by the community members, or whether or not an activity took place within the community.

8. The system of claim 1, wherein
the group manager module allows the group manager to sign up a group member for an activity, decline a group member for an activity or cancel a group member from an activity on their behalf by proxy.

9. The system of claim 1, wherein
the group manager module allows the group manager to set some group members as hidden members, where a group member listing of the group members provided to the group members lists all of the group members other than the hidden members.

10. The system of claim 1, wherein the activity creator module allows the activity creator to set the group members who are sent an activity sign up list of the group members signed up for an activity after the cutoff time.

11. A non-transitory computer readable medium storing a program for operating a system for organizing at least one community, each having a plurality of community members, and at least one group, each having a plurality of group members, the program when executed by a computer, performing a plurality of steps provided by modules, the modules comprising:
a community manager module providing functions for a community manager of the at least one community;
a community member module providing functions for a community member of the at least one community;
a group manager module providing functions for a group manager of the at least one group;
a group member module providing functions for a group member of the at least one group; and
an activity creator module providing functions for an activity creator of the at least one group; and
wherein the at least one community corresponds to a pre-existing member-based organization, and each of said plurality of community members of said at least one community is a member of said corresponding organization,
wherein each community is organized in the system to include individuals, but not groups, and one or more of said individuals is also a member of at least one group,
wherein the at least one community comprises a plurality of communities, and wherein at least one group member is a member of more than one community of the plurality of communities.

12. The computer readable medium of claim 11, wherein the activity creator module allows the activity creator to set a time at which the activity will occur, and provides notification to the group members of the occurrence of an activity start time.

13. The computer readable medium of claim 12, wherein the activity creator module allows the activity creator to set a time at which the activity will occur, where the time of occurrence may be set to occur only within certain months on a seasonal basis.

14. The computer readable medium of claim 11, wherein
the community manager module allows a community manager to set the attributes of a target group of community members to whom a message is sent.

15. The computer readable medium of claim 14, wherein the attributes correspond to an activity associated with the members of the target group, and/or to specific attributes shared by those members.

16. The computer readable medium of claim 11, wherein
the community manager module provides a report to the community manager regarding the use by the community members of the system for organizing.

17. The computer readable medium of claim 16, wherein
the report comprises information of at least one of how many community members have used the system for organizing within a given time range, how many groups exist, an identification of activity creators, how many activities a community member has participated in within a given time period, which community members have used the system for organizing the most or least, an aggregate of the types of activities participated in by the community members, or whether or not an activity took place within the community.

18. The computer readable medium of claim 11, wherein
the group manager module allows the group manager to sign up a group member for an activity, decline a group member for an activity or cancel a group member from an activity on their behalf by proxy.

19. The computer readable medium of claim 11, wherein
the group manager module allows the group manager to set some group members as hidden members, where a group member listing of the group members provided to the group members lists all of the group members other than the hidden members.

20. The computer readable medium of claim 11, wherein the activity creator module allows the activity creator to set the group members who are sent an activity sign up list of the group members signed up for an activity after the cutoff time.

21. A method for operating a system for organizing at least one community, each having a plurality of community members, and at least one group, each having a plurality of group members, comprising:
performing functions, via a computer, of at least one of:
a community manager of the at least one community;
a community member of the at least one community;
a group manager of the at least one group;
a group member of the at least one group; or
an activity creator of the at least one group; and
wherein the at least one community corresponds to a pre-existing member-based organization, and each of said plurality of community members of said at least one community is a member of said corresponding organization,
wherein each community is organized in the system to include individuals, but not groups, and one or more of said individuals is also a member of at least one group,
wherein the at least one community comprises a plurality of communities, and wherein at least one group member is a member of more than one community of the plurality of communities.

22. The method of claim 21, further comprising:
as the activity creator, setting a time at which the activity will occur, and providing notification to the group members of the occurrence of an activity start time.

23. The method of claim 22, further comprising:
as the activity creator, setting a time at which the activity will occur, where the time of occurrence is set to occur only within certain months on a seasonal basis.

24. The method of claim 21, further comprising:
as the community manager, setting the attributes of a target group of community members to whom a message is sent.

25. The method of claim 24, wherein the attributes correspond to an activity associated with the members of the target group, and/or to specific attributes shared by those members.

26. The method of claim 21, further comprising:
providing a report to the community manager regarding the use by the community members of the system for organizing.

27. The method of claim 26, wherein
the report comprises information of at least one of how many community members have used the system for organizing within a given time range, how many groups exist, an identification of activity creators, how many activities a community member has participated in within a given time period, which community members have used the system for organizing the most or least, an aggregate of the types of activities participated in by the community members, or whether or not an activity took place within the community.

28. The method of claim 21, further comprising:
as the group manager, signing up a group member for an activity, declining a group member for an activity or cancelling a group member from an activity on their behalf by proxy.

29. The method of claim 21, further comprising:
as the group manager, setting some group members as hidden members, where a group member listing of the group members provided to the group members lists all of the group members other than the hidden members.

30. The method of claim 21, further comprising:
as the activity creator, setting the group members who are sent an activity sign up list of the group members signed up for an activity after the cutoff time.

31. The system of claim 1, wherein each of the plurality of communities is an entity that is recognized as an organization that has an official membership roster and a well defined, distinct membership.

32. The computer readable medium of claim 11, wherein each of the plurality of communities is an entity that is recognized as an organization that has an official membership roster and a well defined, distinct membership.

33. The method of claim 21, wherein each of the plurality of communities is an entity that is recognized as an organization that has an official membership roster and a well defined, distinct membership.
